(19) United States
(12) Patent Application Publication
(10) Pub. No.: US 2025/0353987 A1
(43) Pub. Date: Nov. 20, 2025

(54) SYSTEMS AND METHODS FOR THE DEGRADATION OF POLYMER MATERIALS

(71) Applicant: DePoly SA, Sion (CH)

(72) Inventors: Bardiya VALIZADEH, Sion (CH); Daniel VALADARES, Sion (CH)

(73) Assignee: DePoly SA, Sion (CH)

(21) Appl. No.: 19/120,358

(22) PCT Filed: Oct. 13, 2023
(86) PCT No.: PCT/EP2023/078580

§ 371 Date: Apr. 11, 2025

Related U.S. Application Data
(60) Provisional application No. 63/416,041, filed on Oct. 14, 2022.

(51) Int. Cl. C08J 11/16; B01J 8/10

(52) U.S. Cl. CPC C08J 11/16; B01J 8/10; C08J 2367/02

(57) ABSTRACT

Provided is a system and associated method for the degradation of plastic materials. The system includes a body, hopper, conveying system, drive system and a UV light assembly. The associated method includes providing a polymer material into the hopper, providing a solvent into the hopper, activating the drive system, and activating the UV light.

### TECHNICAL FIELD

The following relates generally to reactor systems for the degradation of polymer materials. Specifically, the following relates to a conveyor reactor system for the application to the degradation of polymer materials into terephthalic acid (TPA) and/or ethylene glycol and/or other monomers that form the plastic materials.

### INTRODUCTION

PCT Application Publication No. WO2020173961A1 (incorporated herein by reference in its entirety) provides a method of alkaline hydrolysis of one or more plastic polymers into terephthalic acid (TPA) and/or ethylene glycol (EG) and/or other monomers that form the one or more plastic polymers, the method comprising:
a) contacting the one or more plastic polymers with a metal oxide in a solution in the presence of a base to provide a reaction mixture;
b) stirring the reaction mixture during appropriate time under ultraviolet (“UV”) light;
c) recovering terephthalic acid, ethylene glycol and/or the other monomers from the reaction mixture.

The methods of PCT Application Publication No. WO2020173961A1 may be practically difficult to conduct economically at commercial scale with standard or readily available chemical processing equipment. Specifically, current reaction vessels are not well configured to conduct the method of the above cited publication.

Accordingly, there is a need for an improved reaction vessel which may more economically conduct the reaction of the above cited publication.

### SUMMARY

Disclosed herein is a reactor system for the degradation of polymer materials, according to an embodiment. The system includes a hopper, for receiving input materials, the input materials including a polymer, a solvent, a metal oxide, and a base, a body, extending along a first axis, having a first end and second end, wherein the first end is coupled to the hopper, wherein the body may receive input materials introduced into the hopper, a conveying system for conveying the input materials along the body, a drive system for imparting motion to the conveying system and an ultraviolet (“UV”) light for exposing the input materials of the body to UV radiation to degrade the input materials.

According to some embodiments, the body is fluid tight, and a liquid is contained by the body. According to some embodiments, the polymer comprises any one of: poly lactic acid, polyethylene terephthalate, polybutylene terephthalate, polytrimethylene terephthalate, polyethylene isosorbide terephthalate, polyethylene furanoate, polyvinyl chloride, and polyvinylidene chloride, or combinations thereof.

According to some embodiments, the conveying system is positioned within the reactor system, such that the conveying system may convey materials introduced into the hopper from the hopper and into the body. According to some embodiments, the conveying system is positioned within the reactor system, such that the conveying system may convey materials from the first end of the body to the second end of the body.

According to some embodiments, the conveying system comprises an Archimedes screw, the Archimedes screw comprising a central axis, wherein the Archimedes screw is configured to convey input materials along the body. According to some embodiments, the drive system is coupled to the Archimedes screw, and the drive system is configured to rotate the Archimedes screw about the central axis of the Archimedes screw. According to some embodiments, the Archimedes screw comprises a length between 1 and 10 meters.

Disclosed herein is a method of operating a reactor system, according to an embodiment. The method includes providing a polymer material into the hopper, providing a solvent into the hopper, activating the drive system and activating the UV light. According to some embodiments, the solvent comprises ethanol. According to some embodiments, the method further comprises providing a metal oxide into the hopper. According to some embodiments, the method further comprises providing a base into the hopper. According to some embodiments, the materials provided to the reactor comprise a pH greater than 7. According to some embodiments, the drive system is configured to rotate the conveyor system at a speed greater than 30 revolutions per minute.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a perspective view of a screw conveyor reactor system, according to an embodiment;

FIG. 2 is a partial perspective view of a screw conveyor reactor system of FIG. 1, according to an embodiment;

FIG. 3 is a perspective view of an Archimedes screw of the screw conveyor reactor system of FIGS. 1-2 in isolation, according to an embodiment;

FIG. 4 is a frontal cross-sectional view of the screw conveyor reactor system of FIGS. 1-3, along section A-A of FIG. 1, according to an embodiment;

FIG. 5 is a detail perspective view of the UV light assembly of the screw conveyor reactor system of FIGS. 1-4, according to an embodiment;

FIG. 6A is a perspective view of a dual parallel arrangement of the screw conveyor reactor system of FIGS. 1-5, according to an embodiment;

FIG. 6B is a side view of a dual parallel arrangement of the screw conveyor reactor system of FIGS. 1-5, according to an embodiment;

FIG. 6C is a top view of a dual parallel arrangement of the screw conveyor reactor system of FIGS. 1-5, according to an embodiment;

FIG. 6D is a perspective view of a dual parallel arrangement of the screw conveyor reactor system of FIGS. 1-5, according to an embodiment;

FIG. 6E is a front view of a dual parallel arrangement of the screw conveyor reactor system of FIGS. 1-5, according to an embodiment;

FIG. 6F is a perspective view of a dual parallel arrangement of the screw conveyor reactor system of FIGS. 1-5, according to an embodiment;

FIG. 7 is a perspective view of an Archimedes screw of a screw conveyor reactor system in isolation, according to another embodiment;

FIG. 8 is a schematic block diagram of a conveyor reactor system, according to an embodiment;

FIG. 9 is a flow chart of a method of operating the screw conveyor reactor system of FIGS. 1-8, according to an embodiment; and

FIG. 10 is a flow chart of a method of operating the screw conveyor reactor system of FIGS. 1-8, according to another embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article. Associated with the screw conveyor reactor system described herein is a method of degradation of plastic materials into terephthalic acid (TPA), ethylene glycol and/or other monomers that form the plastic materials.

The method comprises: contacting the one or more plastic polymers with a metal oxide in a solution in the presence of a base to provide a reaction mixture; Stirring the reaction mixture for an appropriate time under ultraviolet (“UV”) light; and Recovering terephthalic acid, ethylene glycol and/or the other monomers from the reaction mixture.

The process comprises an alkaline hydrolysis of polymers, namely polyethylene terephthalate (PET). This process may be conducted at room temperature, with relatively high efficiency, in comparison to other methods of polymer degradation into constituent monomers.

In some embodiments, the solvent is ethanol or an ethanol-water mixture. In some embodiments, the polymer is polyethylene terephthalate (PET). In some embodiments, the metal oxide is TiO2. In some embodiments, the base is NaOH. In some embodiments, the reaction mixture has an initial pH of 14. In some embodiments, the reaction mixture is stirred at room temperature.

After recovery, the terephthalic acid may be of low purity. For example, the terephthalic acid may be contaminated with various impurities, and may require further processing to obtain terephthalic acid that is commercially useful, wherein the terephthalic acid may be provided to processes configured to require virgin terephthalic acid.

In embodiments wherein the solvent is ethanol or an ethanol-water mixture, after stirring the reaction mixture, and recovering terephthalic acid, ethylene glycol may be present within a liquid mixture of water, ethanol and ethylene glycol, in various proportions, depending on the specifications of the embodiment. Additional processes may be required to recover ethylene glycol from the water-ethanol-ethylene glycol mixture. After separating the ethylene glycol from the water-ethanol-ethylene glycol mixture, the resulting water-ethanol glycol mixture may be reused in additional operations or iterations of the process described herein, or in other processes.

While the process described herein, and in greater detail in PCT Application Publication No. WO2020173961A1 is described in reference to the degradation of polyethylene terephthalate into constituent monomers, the process may be applied to the degradation of other polymer materials, into other constituent monomers.

Described herein is a conveyor reactor system and associated methods. While the systems and methods described herein may be particularly well suited for use for the room temperature alkaline polymer hydrolysis process described above, and in PCT Application Publication No. WO2020173961A1, in some embodiments, the conveyer reactor system described herein may be applied to other processes.

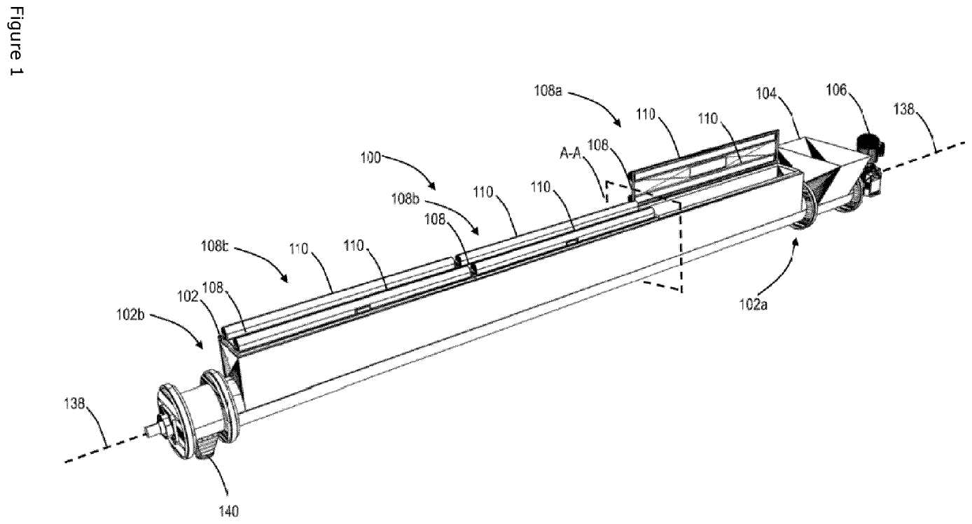

Referring now to FIGS. 1 & 2, pictured therein are perspective views of a screw conveyor reactor system 100, according to an embodiment. The reactor system 100 comprises a body 102, hopper 104, lid 108, conveying system such as an Archimedes screw 112, drive system 106, outlet 140, and ultraviolet (UV) light assembly 110.

The body 102 comprises a generally rectangular trough, having a length, extending along a first axis 138. The body 102 is configured to be fluid tight, such that fluids introduced into the body 102 may not escape from the body. The body 102 may be constructed from stainless steel or another material which provides sufficient mechanical strength, fluid tightness, and chemical resistance to the contents present within the body 102 during operation of system 100 (e.g. highly basic materials, having a pH of 14). While the embodiment shown herein comprises a generally rectangular shape, in other embodiments, body 102 may comprise other shapes.

Body 102 further comprises lids 108. Lids 108 are hinged onto sidewalls of body 102, such that lids 108 may be rotated into an open position 108a and closed position 108b. When placed into closed position 108b, lids 108 may seal body 102, such that contents may not splash out of body 102 during operation of system, and volatile compounds may not exit body 102, reducing possible hazards from exposure to volatile compounds by nearby human operators of system 100. In some examples, the interfaces between body 102 and lids 108 may comprise gaskets to provide a fluid tight seal when in the closed position 108b. A gasket may provide a fluid tight seal for liquids and volatile compounds may be applied to system 100.

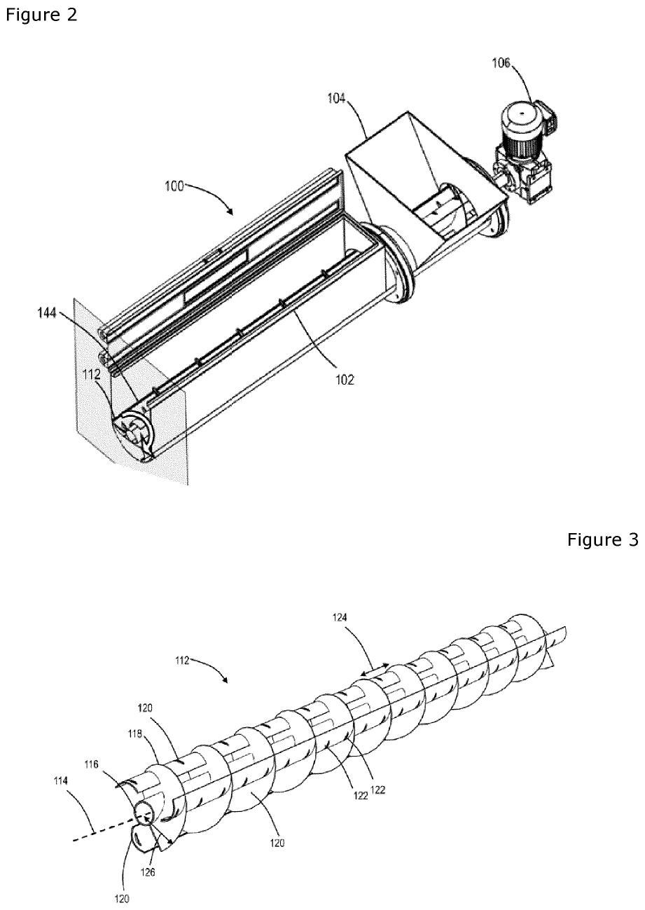

In the embodiment of FIGS. 1-2, the lower portion of the body 102 comprises a rounded profile, mirroring the external profile of the Archimedes screw 112.

Hopper 104 comprises a container, coupled to the body 102, at the first end 102a of the body. Hopper 104 is a generally square funnel shaped structure, with an open top. In some embodiments, hopper 104 may further comprise a removeable lid, to prevent materials and or volatile substances from exiting hopper 104 during the operation of system 100. Hopper 104 is coupled to body 102, such that materials introduced into hopper 104 may exit hopper 104 and pass into body 102. Hopper 104 may be constructed from stainless steel or another material that provides sufficient mechanical strength, fluid tightness, and chemical resistance to the contents present within hopper 104 during operation of system 100 (e.g. highly basic materials, having a pH of 14).

Hopper 104 is configured to receive input materials into the system 100, for example, polymer material for degradation, solvents, pH adjusting chemicals, catalysts and/or other materials, and pass these materials into body 102. In some embodiments, hopper 104 may be absent from system 100, and system 100 may be supplied with materials thorough alternate means. For example, another machine or component may input materials directly into body 102, through an aperture in body 102. In some examples, hopper 104 may be integrated into body 102 or other components of system 100.

Drive system 106 comprises a device which may impart rotational motion to another object. The drive system 106 may comprise an electric motor, gasoline engine, diesel engine, the output shaft of another machine or system, or another device that imparts rotational motion to another object. The drive system 106 may further comprise a gearbox to adjust output speed, control electronics, rotational speed sensors, torque sensors, an external control interface or other auxiliary components.

Ultraviolet light assembly 110 comprises components configured to emit light in the ultraviolet spectrum. Ultraviolet light assembly 110 may cast UV spectrum light onto the contents of body 102. Ultraviolet light assembly 110 extends along the length of body 102, such that contents at different positions within body 102 may be exposed to UV light during the operation of system 100. Outlet 140 comprises an opening, coupled to body 102, such that contents within body 102 may exit system 100 through outlet 140. In some examples, the size and shape of outlet 140 may be particularly configured such that materials exiting through outlet 140 are extruded with a specific profile, for further processing.

In some examples, system 100 may further comprise a cooling and/or heating system configured to maintain components or environments of system 100 within specific temperature ranges. Such temperature control systems may be computer controlled, and may comprise resistive heating elements, heat pumps, refrigeration systems, fuel fired heating elements, or any other suitable heating or cooling components.

Referring now to FIG. 3, pictured therein is a perspective view of conveying system such as an Archimedes screw 112 of the reactor system 100, in isolation. Archimedes screw 112 comprises a long central shaft 116, extending along a central axis 114, with a continuous spiral blade 118 positioned substantially perpendicular to the central shaft 116 of the Archimedes screw 112. Spiral blade 118 comprises a pitch 124 dimension. Pitch 124 may vary according to the specific application of system 100.

Archimedes screw 112 may be mounted to body 102, hopper 104, and or other components of system 100 in a manner than enables rotation of Archimedes screw 112, about central shaft 116. For example, Archimedes screw 112 may be coupled to body 102 through rotational bearings. In some examples, such rotational bearings may be configured to be fluid tight, or chemically resistant.

When rotated about central shaft 116, Archimedes screw 112 may convey materials from hopper 104 to body 102, and along the length of body 102, from first end 102a to second end 102b, as blade 118 will urge materials along the length of body 102 as Archimedes screw 112 rotates. Archimedes screw 112 may be constructed from stainless steel or another material that provides sufficient mechanical strength, fluid tightness, and chemical resistance to the contents present within the body 102 during operation of system 100 (e.g. highly basic materials, having a pH of 14).

In the embodiment of FIGS. 1-3, Archimedes screw 112 additionally comprises three scoops 120, extending along the length of Archimedes screw 112, parallel or helicoidal to axis 114, periodically intersecting spiral blade 118. In some embodiments, scoops 120 do not extend to the central shaft 116, such that there is a gap between each scoop 120 and the central shaft 116, along the length of the Archimedes screw 112, to allow for some liquid egress through Archimedes screw 112 during the operation of system 100. This liquid egress may provide for more thorough mixing of contents, and may additionally reduce mechanical stress on the Archimedes screw 112, associated components (e.g. mounting hardware and bearings), drive system 106, as well as reduce torque requirements of the drive system 106.

Each scoop 120 comprises a concave, curved profile. This curved profile enables the Archimedes screw 112 to scoop contents from lower portions of body 102, and pull these contents to upper portions of body 102, such that contents may be uniformly exposed to UV light during operation of system 100. The exact dimensions, number and shape of the scoops 120 may be adjusted, depending on the use case of system 100. For example, if the use case of system 100 includes conveying and mixing more viscous contents, dimensions may be altered for more thorough mixing, and reduction of mechanical stress of each component. The curved shaped of scoops 120 of the present embodiment may reduce mechanical stresses on scoops 120, and Archimedes screw 112, which may further reduce torque requirements of drive system 106.

The presence of scoops 120 may promote mixing and agitation of contents within body 102 when system 100 is in operation and Archimedes screw 112 is rotating. Additionally, scoops 120 may mix and adjust the position of contents of system 100, such that contents may be more uniformly exposed to UV light emitted by UV light assembly 110, improving process efficiency.

Between each intersection of each scoop 120 with spiral blade 118, present on the surface of each scoop 120 are two apertures 122. In the present embodiment, each aperture 122 is approximately elliptical in shape, with a large aspect ratio. According to some embodiments, the aspect ratio of each elliptical aperture 122 may be approximately 10. In other embodiments, different numbers of apertures 122 may be present on each scoop 120, and apertures 122 may comprise different sizes and shapes, including, but not limited to, circular, square, polygonal, or another shape.

The presence of apertures 122 may promote mixing and agitation of contents within body 102. Such increased mixing and agitation may improve process efficiency, according to some embodiments. Additionally, apertures 122 may mix and adjust the position of contents of system 100, such that contents may be more uniformly exposed to UV light emitted by UV light assembly 110, improving process efficiency.

Referring now to FIG. 4, pictured therein is a front cross-sectional view of screw conveyor reactor system 100, along section A-A of FIG. 1. Visible in FIG. 4 is Archimedes screw 112, positioned within body 102. Body 102 comprises bottom surface 128. Bottom surface 128 comprises a continuously curved portion of material, joining each vertical side of body 102. The radius of curvature of bottom surface 128 is configured to substantially match or correspond to the external radius 126 of Archimedes screw 112, such that when Archimedes screw 112 is positioned within body 102 in an operational position, little to no space is present between the external envelope of Archimedes screw 112, and bottom surface 128. This configuration improves the ability of Archimedes screw 112 to convey materials along body 102, from first end 102a, to second end 102b, as little space is present between the external radius 126 of Archimedes screw 112 and the bottom surface 128 of body 102 for materials to settle and stagnate.

Additionally visible in FIG. 4 is liquid level 134. Liquid level 134 comprises the level at which the mixture of fluids (e.g. solvents, and other fluids), and input polymer materials sits at rest, when the system 100 is in an operational state. In some embodiments, it may be preferable for liquid level 134 to rest above the external diameter of central shaft 116. Such a liquid level may improve process efficiency over other liquid levels, according to some embodiments. According to some embodiments, such a liquid level 134 provides for an advantageous ratio of volume of reaction mixture to reaction mixture surface area in contact with UV light. Increasing liquid level above this height may maintain the reaction mixture area in contact with the UV light however, the volume of the reaction mixture will increase. If the liquid level is lower than level 134, the area of the reaction mixture in contact with UV light will decrease, as UV light exposure may be obscured by the central shaft 116, scoops 120 and/or blade 118. This UV light exposure area of the reaction mixture may decrease at a rate greater than the decrease in volume, depending on the geometry of system 100.

Body 102 further comprises a vertical wall dimension 142, as seen in FIG. 4. Vertical wall dimension 142 may be specifically configured such that when system 100 is in operation, contents within body 102 are unlikely to be directed, lifted, or splashed to a level above the upper extreme of vertical wall dimension 142. This may reduce material splashing and residue deposition on components of UV light assembly 110, which may reduce the intensity of UV light output, or damage components of UV light assembly 110. Similarly, as the distance between UV light assembly 110 and the contents of body 102 (e.g. liquid level 134) increases, UV light intensity will decrease, according to the inverse square law. Vertical wall dimension 142 may be configured to optimize and balance content splashing and UV light intensity.

Referring now to FIG. 5, pictured therein is a detailed perspective view of UV light assembly 110 of reactor system 100. UV light assembly 110 further comprises UV light source 130, reflector 136 and UV screens 132a, 132b. UV light source 130 comprises a source that outputs electromagnetic radiation in the ultraviolet wavelength spectrum (10 nm-400 nm wavelength). Preferably, UV light source 130 emits electromagnetic radiation in the UVA wavelength spectrum (315 nm-400 nm wavelength), at a relatively high intensity. UV light source 130 may be a fluorescent light source, light emitting diode source, or another light source. In the embodiment of FIG. 5, UV light source 130 is a fluorescent tube type UV light source 130, comprising two parallel lengths of UVA emitting fluorescent tubes.

Reflector 136 comprises a component positioned between UV light source 130 and the interior of body 102. Reflector 136 reflects UV light cast by UV light source 130 back to the interior of body 102, improving the efficiency of UV light transmission from UV light source 130 to the contents of body 102. Additionally, reflector 136 prevents UV light emitted by the UV light source 130 from escaping from the interior of body 102, reducing the risk of UV light exposure to nearby individuals and operators of reactor system 100. Reflector 136 may be constructed from polymer, metal, glass or another appropriately reflective material, and coated with a thin layer of a UV reflective coating. In other embodiments, reflector 136 is constructed in a manner which may reflect received UV light, and block UV light from passing through the reflector 136.

UV screen 132a comprises a solid component that is transparent to UV light. UV screen 132a is positioned between UV light source 130 and the interior of body 102, such that contents within body 102 may not contact UV light source 130. According to some applications of system 100, contents within body 102 may be corrosive, or otherwise damaging to sensitive electrical components, such as UV light source 130 or associated components. UV screen 132a may advantageously protect UV light source 130 from contacting contents within body 102, preventing damage to portions of system 100. UV screen 132a may be easily cleaned or serviced as necessary.

UV screen 132b comprises a solid component that is opaque to UV light, but at least partially transparent to visible light. UV screen 132b is positioned on the lid 108 covering the interior of body 102, such that when lid 108 is closed, visible light may pass through UV screen 132b of lid 108, but UV light may not pass through UV screen 132b of lid 108. UV screen 132b may advantageously allow an operator to visually assess the contents and processes occurring within body 102 when lid 108 is closed and system 100 is operational, while minimizing risk of exposure to UV light, which may be harmful to human operators. UV screen 132b may be easily cleaned or serviced as necessary.

In some examples, system 100 may alternatively comprise a cooling or protective fluid stream instead of or in addition to UV screen 132a. This fluid stream may prevent contents of body 102 or system 100 from splashing onto UV light source 130, preventing damage of components of system 100. Additionally, such a cooling or protective fluid stream may remove heat from UV light source 130, improving UV light source 130 performance, or longevity. Such a cooling or protective fluid stream may be transparent to UV light, and may comprise a stream of air, water, or other suitable fluid.

According to an embodiment, in operation of screw conveyor reactor system 100, polymer materials for degradation are introduced into the hopper 104, and a solvent (e.g. ethanol or an ethanol water mix) is introduced into the body 102, either directly into the body or into the body through the hopper. Additionally, a metal oxide catalyst (e.g. TiO2), as well as a base (e.g. NaOH) may be introduced into body 102, either directly, or through hopper 104.

In some examples, the polymer materials introduced into system 100 may be selected from the group including, without limitation: poly lactic acid (PLA), polyethylene terephthalate (PET), polybutylene terephthalate (PBT), polytrimethylene terephthalate (PTT), polyethylene isosorbide terephthalate (PEIT), polyethylene furanoate (PEF), polyvinyl chloride (PVC), and polyvinylidene chloride (PVDC), or combinations thereof.

In some examples, the solvent introduced into system 100 may be selected from the group including without limitation: methanol, ethanol, propanol, butanol, pentanol or combinations thereof.

In some examples, the catalyst introduced into system 100 may be selected from the group including, without limitation: TiO₂, V2O5, Cr2O3, CrO3, Mn2O3, FeO, Fe2O3, Fe3O4, Co2O3, NiO, CuO, Cu2O, ZnO, ZrO₂, Nb₂O₅, Mo₂O₃, RuO, RuO₂, RuO₄, RhO₂, Rh₂O3, PdO, Ag₂O, Ag₂O₂, CdO, In₂O₃, Al₂O₃, La₂O₃, CeO₂, Ce₂O₃, HfO₂, Ta₂O₅, WO₃, ReO₂, ReO₃, Re₂O₃, OsO₂, OsO₄, IrO₂, PtO₂, Au2O3, Li2O, Na2O, K2O, MgO, CaO, SrO, BaO, and P25, or combinations thereof.

In some examples, the base introduced into system 100 may be selected from the group including, without limitation: NaOH, NaOMe, NaOEt, NaOPr NaO^{t}Bu, KOH, KOMe, KOEt, KOⁱPr KO^{t}Bu, LiOH, LiOMe, LiOEt, LiOⁱPr, LiO^{t}Bu, Rb(OH), RbOMe, RbOEt, RbOⁱPr, RbO^{t}Bu CsOH, CeOMe, CsOEt, CsOⁱPr, CsO^{t}Bu, Fr(OH), FrOMe, FrOEt, FrOⁱPr, FrO^{t}Bu, Be(OH)₂, Be(OMe)₂, Be(OEt)₂, Be(OⁱPr)₂, Be(O^{t}Bu)₂, Mg(OH)₂, Mg(OMe)₂, Mg(OEt)₂, Mg(OⁱPr)₂, Mg(^{t}OBu)₂, Ca(OH)₂, Ca(OMe)₂, Ca(OEt)₂, Ca(OⁱPr)₂, Ca(^{t}OBu)₂, Sr(OH)₂, Sr(OMe)₂, Sr(OEt)₂, Sr(OⁱPr)₂, Sr(^{t}OBu)₂, Ba(OH)₂, Ba(OMe)₂, Ba(OEt)₂, Ba(OⁱPr)₂, Ba(^{t}OBu)₂, Ra(OH)₂, Ra(OMe)₂, Ra(OEt)₂, Ra(OⁱPr)₂, Ra(tOBu)₂, and NH4(OH), or combinations thereof.

Once these materials have been introduced into system 100, drive system 106 and UV light assembly 110 may be activated, imparting rotation into Archimedes screw 112, and exposing contents within body 102 to UV light. As Archimedes screw 112 rotates, contents within body 102 and hopper 104 are conveyed towards the second end 102b of system 100. Contents of system 100 are constantly mixed by the rotation of Archimedes screw 112, pulling materials from the bottom of body 102 to the top of body 102, such that contents may be exposed to UV light in a relatively uniform manner.

As contents within system 100 are conveyed from hopper 104 and first end 102a, such that they are directed towards second end 102b and outlet 140. As contents move towards second end 102b, the contents continuously react, such that once contents reach second end 102b and outlet 140, the contents have been completely processed, as per the specification of the desired chemical process being applied by the system 100.

Components of system 100 may be configured such that the desired chemical process is completed once contents reach second end 102b and outlet 140, such that materials exiting outlet 140 have been fully processed. For example, radius 126, pitch 124, and length of Archimedes screw 124, dimensions of body 102 and hopper 104, curvature, position and number of scoopers 120, number, shape and size of apertures 122, intensity of UV light incident on contents, rotational speed of Archimedes screw 112, and other parameters which may impact process rate may be configured according to the desired chemical process to be applied by system 100.

The mechanical design of system 100 is configured to improve the chemical process, by applying a continuous process, improving reaction mixing, maintaining reaction mixture homogeneity wherein the action of the blades ensure that the reaction mixture is homogeneous and is in periodic contact with UV light, ensuring that input reactants do not settle or stagnate within system 100, and ensuring that the reaction mixture is in constant motion and constant contact with UV light, to avoid system 100 clogs due to material drying or otherwise and deposition of material onto UV light source 130.

The modular mechanical design of system 100 further allows a process conducted by system 100 to be modified in scale or otherwise optimized as needed. For example, multiple systems 100 may be chained together to increase the scale of the underlying process. The overall structure and design of system 100 allows for easy cleaning and maintenance, as the internal services of body 102 are easily accessible. Further, system 100 may be maintained, modified, or serviced during operation, as system 100 is easily accessible through lid 108.

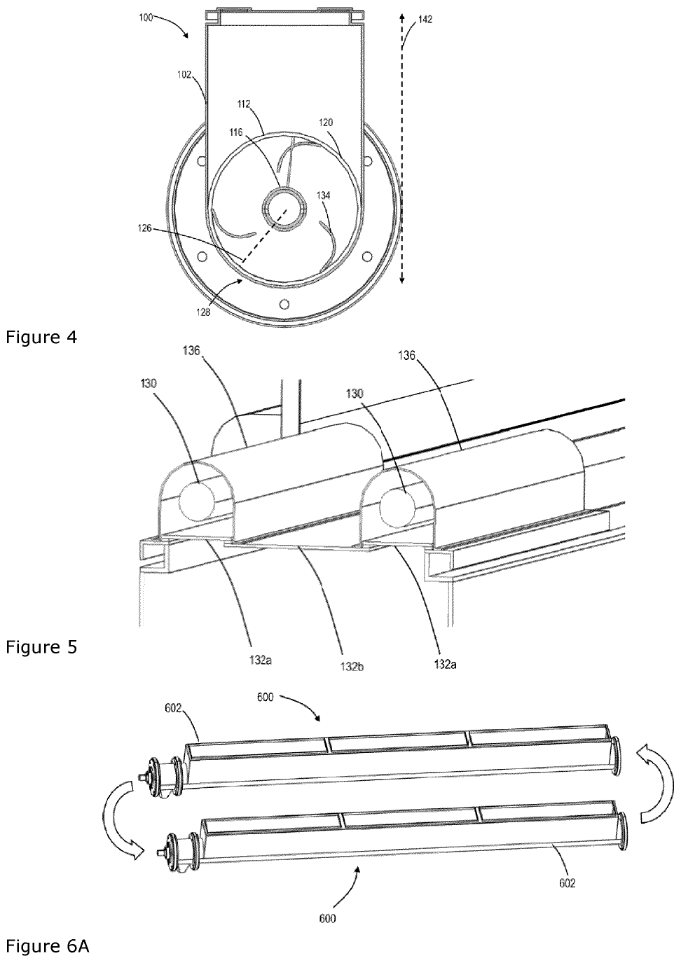

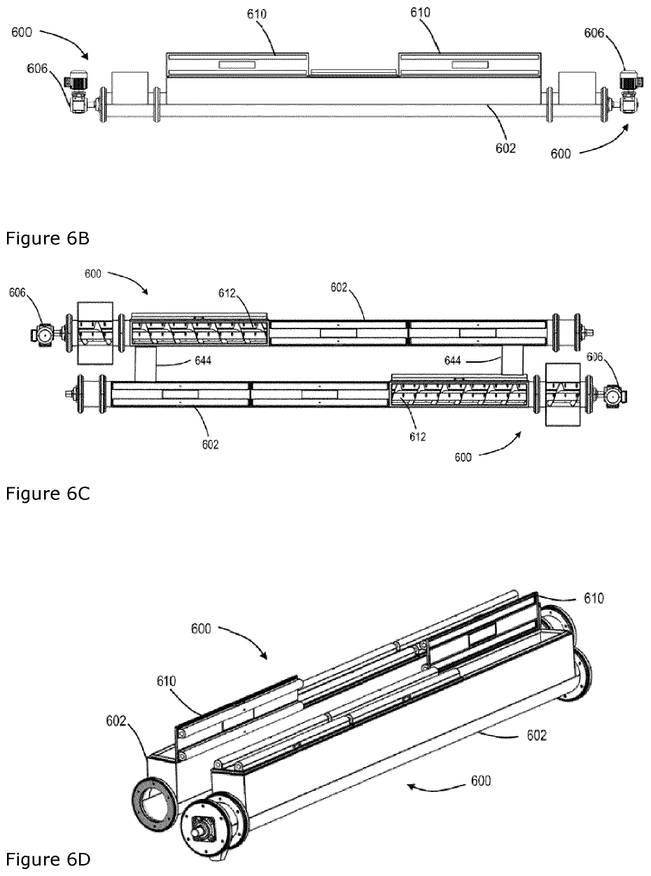

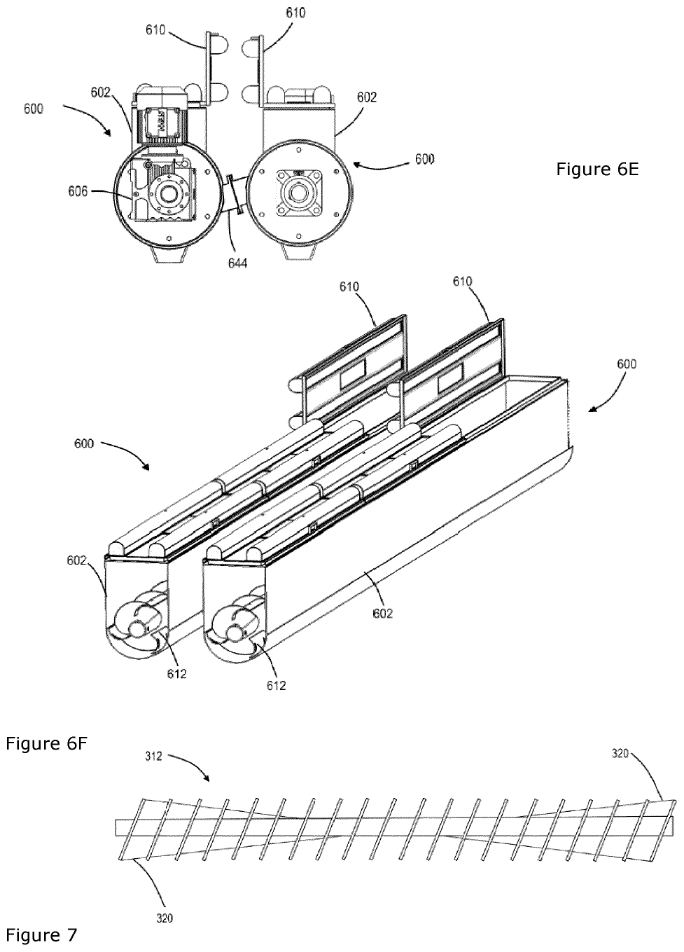

Referring now to FIGS. 6A to 6F, pictured therein are assorted views of a pair of screw conveyor reactor systems 100, pictured with and without various components, arranged in parallel configurations. The screw conveyor reactors do not include hoppers, and instead, the outlet of the first screw conveyor reactor feeds into the inlet of the second screw conveyor reactor, while the outlet of the second screw conveyor reactor feeds into the inlet of the first screw conveyor reactor. Such a dual, parallel arrangement may allow for continuous operation, wherein materials within the bodies of the screw conveyor reactor systems 100 is continuously circulated between screw conveyor reactors, in contrast to the configuration of the embodiment of FIGS. 1-5, wherein input materials are provided into the hopper 104, and conveyed along body 102, mixing input materials and exposing this mixture to UV light to complete the desired chemical process (e.g. room temperature degradation of PET). In the embodiments of FIGS. 6A to 6F, the pair of screw conveyor reactor systems 600 may be contained to contain a total sum of 150 L of fluid within the bodies of both reactors (i.e. each reactor may contain 75 L of fluid). The screw conveyor reactor systems 600 may be the screw conveyor reactor systems 100 as described with reference to FIGS. 1 to 5.

In the embodiments of FIGS. 6A to 6F, screw conveyor reactor systems 600 may be coupled in series or in a loop configuration. In series configurations, the reactors may be coupled in a planar mode or in vertical mode. In vertical mode, the system may be configured to operate in ascending or descending configurations. In a descending configuration, contents within a reactor may be urged by gravity towards the outlet or the next reactor in the series. In an ascending configuration, one reactor may be positioned such that the outlet of the reactor is at the same vertical level as the inlet of the next reactor. The systems 600 comprise components analogous to systems 100 and 400, with reference characters incremented by 500 and 200 respectively. Description herein in reference to systems 100 and 400 similarly applies to system 600.

For example, visible in FIGS. 6A to 6F include body 602, drive system 606, UV light 610, and conveying subsystem 612. Also visible in FIGS. 6C and 6E are system couplings 644. System couplings 644 couple individual reactor systems 600 to one another, to form loop or series configurations, wherein material in one reactor system may be transferred to another reactor system, through system coupling 644. While system couplings 644 are shown in specific forms and positions, in other embodiments, the configuration, number and position of system couplings 644 may vary.

Referring now to FIG. 7, pictured therein is an alternate embodiment of an Archimedes screw 312, for use in a screw conveyor reactor system, such as system 100 described herein. Screw 312 differs from screw 112 in that screw 312 comprises two scoops 320 versus the three scoops 120 of screw 112. Additionally, scoops 320 of screw 312 are configured in a spiral arrangement, versus the linear arrangement of scoops 120. Each scoop 320 rotates radially 180° along the length of screw 312, such that a scoop 320 beginning at a first position at one end of screw 312 will be positioned 180° away from the first position, opposite a central axis of the screw 312 at the opposite end of screw 312. Such a radial rotation of scoops 320 may increase process efficiency, by more uniformly exposing the contents of system 100 to UV light during operation.

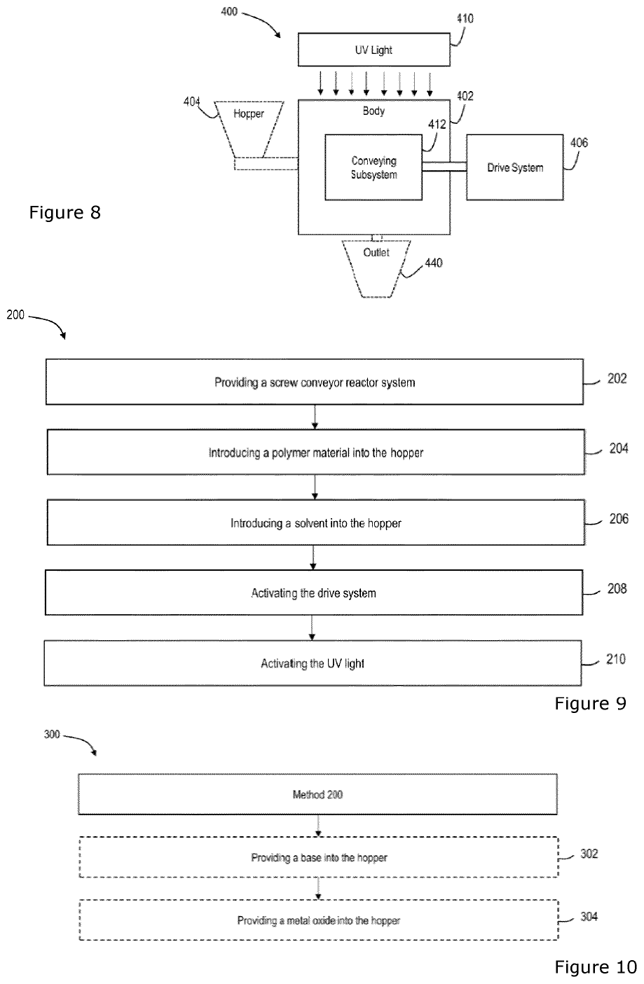

Referring now to FIG. 8, pictured therein is a schematic block diagram of a conveyor reactor system 400, according to an embodiment. System 400 comprises a body 402, drive system 406, conveying system 412, UV light 410, and optionally, outlet 440, and hopper 404. Components of system 400 may have attributes of system 100, with the reference characters of each component incremented by 300. Details of components of system 100 may apply to system 400.

Body 402 comprises a structure which holds and contains process inputs, such as polymers, solvents, bases, metal oxides and other fluids, solids, or mixtures. Body 402 is the main container or vessel within which chemical reactions take place.

Conveying system 412, is positioned within body 402, and configured to convey materials from one position within body 402 to another position within body 402. Conveying system 412 additionally mixes the contents within body 402, to ensure uniformity of the contents of body 402, as well as to uniformly expose the contents of body 402 to UV light. Conveying system 412 includes a structure or device which conveys contents from one position within body 402 to another position.

Drive system 406 comprises a device coupled to conveying system 412 to impart motion to conveying system 412. Drive system 406 may comprise a motor, engine, actuator, external force input (e.g. input shaft), or another device to impart motion to another device.

UV light 410 comprises a device which may output electromagnetic radiation between the wavelengths of 10 nm-400 nm. UV light 410 is positioned above body 402, such that the contents of body 402 may be exposed to UV wavelength light while system 400 is in operation. In some examples, UV light 410 may be integrated into body 402.

System 400 may optionally further comprise hopper 404 and outlet 440. Hopper 404 is coupled to body 402, such that materials are introduced into hopper 404, and passed into body 402. In some examples, hopper 402 is integrated into body 402, such that body 402 and hopper 404 comprise a single component.

Outlet 440 comprises a structure coupled to body 402, such that contents within body 402 may be expelled from system 400 through outlet 440. In some examples, outlet 440 may be integrated into body 402, such that outlet 440 and body 402 comprise a single component.

In some examples, outlet 440 may comprise different shapes and positions. Outlet 440 may be positioned at a bottom portion of body 402, positioned laterally on body 402 or aligned with an axis of conveying system 412. Outlet 440 may further comprise a strainer or other components configured to collect, separate or filter materials exiting the system 400, for example, unreacted solution, impurities or other materials of interest.

Referring now to FIG. 9, pictured therein is a flowchart outlining a method 200 of operating the screw conveyor reactor systems of FIGS. 1-8. Method 200 includes steps 202, 204, 206, 208, and 210. While the flow chart of FIG. 9 depicts an ordered linear method, method steps 202, 204, 206, 208, and 210 may be performed in any order. At step 202, a screw conveyor reactor system is provided. The screw conveyor reactor system may be screw conveyor reactor system 100, as described in reference to FIGS. 1-8, or any variation thereof.

At step 204, a polymer material is introduced into the hopper of the reactor system.

At step 206, a solvent is introduced into the hopper of the reactor system.

At step 208, the drive system of the reactor system is activated.

At step 210, the ultraviolet light of the reactor system is activated.

In some examples of method 300, step 206 may be performed first, followed by step 208, and then step 204.

Referring now to FIG. 10, pictured therein is a flowchart outlining an alternative method 300 of operating the reactor system of FIGS. 1-8. Method 300 may include any or all steps of method 200, in any order, and additionally includes steps 302 and/or 304. At step 302, a base is provided into the hopper.

At step 304, a metal oxide is provided into the hopper.

While the above description provides examples of one or more apparatus, methods, or systems, it will be appreciated that other apparatus, methods, or systems may be within the scope of the claims as interpreted by one of skill in the art.

1. A reactor system for the degradation of polymer materials, the system comprising:
a hopper, for receiving input materials, the input materials including a polymer, a solvent, a metal oxide, and a base;
a body, extending along a first axis, having a first end and second end, wherein the first end is coupled to the hopper, wherein the body may receive input materials introduced into the hopper;
a conveying system for conveying the input materials along the body;
a drive system for imparting motion to the conveying system; and
an ultraviolet (“UV”) light for exposing the input materials of the body to UV radiation to degrade the input materials.

2. The system of claim 1, wherein the body is fluid tight, and a liquid is contained by the body.

3. The system of claim 1, wherein the polymer comprises any one of: poly lactic acid, polyethylene terephthalate, polybutylene terephthalate, polytrimethylene terephthalate, polyethylene isosorbide terephthalate, polyethylene furanoate, polyvinyl chloride, and polyvinylidene chloride, or combinations thereof.

4. The system of claim 1, wherein the conveying system is positioned within the reactor system, such that the conveying system may convey materials introduced into the hopper from the hopper and into the body.

5. The system of claim 1, wherein the conveying system is positioned within the reactor system, such that the conveying system may convey materials from the first end of the body to the second end of the body.

6. The system of claim 1, wherein the conveying system comprises an Archimedes screw, the Archimedes screw comprising a central axis, wherein the Archimedes screw is configured to convey input materials along the body.

7. The system of claim 6, wherein the drive system is coupled to the Archimedes screw, and the drive system is configured to rotate the Archimedes screw about the central axis of the Archimedes screw.

8. The system of claim 6, wherein the Archimedes screw comprises a length between 1 and 10 meters.

9. A method of operating the system of claim 1, the method comprising:
providing a polymer material into the hopper;
providing a solvent into the hopper;
activating the drive system; and
activating the UV light.

10. The method of claim 9, wherein the solvent comprises ethanol.

11. The method of claim 9, further comprising providing a metal oxide into the hopper.

12. The method of claim 9, further comprising providing a base into the hopper.

13. The method of claim 12, wherein the materials provided to the reactor comprise a pH greater than 7.

14. The method of claim 9, wherein the drive system is configured to rotate the conveyor system at a speed greater than 30 revolutions per minute.
